(19) United States
(12) Patent Application Publication
(10) Pub. No.: US 2019/0016866 A1
(43) Pub. Date: Jan. 17, 2019

(54) THERMALLY CURABLE COMPOSITION

(71) Applicant: Henkel AG & Co. KGaA, Duesseldorf (DE)

(72) Inventors: Hiroko Okuno, Yokohama-shi (JP); Shingo Tsuno, Yokohama-shi (JP); Makoto Ohkubo, Yokohama-shi (JP)

(21) Appl. No.: 16/132,603

(22) Filed: Sep. 17, 2018

Related U.S. Application Data
(63) Continuation of application No. PCT/JP2017/012213, filed on Mar. 17, 2017.

(30) Foreign Application Priority Data
Mar. 22, 2016 (JP) 2016-056539

(51) Int. Cl. C08J 9/10; C08L 9/06; C08L 25/02; C08J 9/12; C08J 9/00

(52) U.S. Cl. CPC C08J 9/105; C08L 9/06; C08J 2203/04; C08J 9/12; C08J 9/0066; C08L 25/02

(57) ABSTRACT

A thermally curable composition having excellent vibration damping properties, and having a small decrease in strength even if heated at high temperature is provided. The thermally curable composition contains a component (a) comprising (a1) a solid rubber, (a2) an olefinic double bond-containing polymer which is liquid or pasty at 22° C., (a3) a hydrocarbon resin in an amount of 0 to 22% by weight based on the total weight of the composition, and (a4) a liquid polydiene; and a component (b) comprising (b1) sulfur in an amount of 1 to 3% by weight based on the total weight of the composition, and (b2) an organic vulcanizing agent in an amount of 0 to 0.2% by weight based on the total weight of the composition.

This application claims benefit under Paris Convention of Japanese Patent Application No. 2016-056539 filed on Mar. 22, 2016, incorporated herein by reference in its entirety.

### TECHNICAL FIELD

The present invention relates to a thermally curable composition, and particularly to a thermally curable composition which provides a cured product having excellent vibration damping properties and having small decrease in strength after high temperature heating, and to a cured product thereof.

### BACKGROUND ART

In today's vehicle construction (passenger cars, buses, trains, and the like), the individual parts of the structures, for example, attachments, paneling, roof area, and vehicle floor, are equipped with acoustic attenuating compounds having a vibration damping/soundproofing function in order to reduce or prevent various vibrations generated in the structures and noise transmission generated from the vibrations. The acoustic attenuating compounds known to date include bitumen in the form of mats that are tailored to each vehicle geometry, and injection-and extrusion-moldable compounds based on rubbers, epoxies, and aqueous (acrylate) dispersions. These acoustic attenuating compounds are mainly applied to the surfaces of car bodies or the paint areas of vehicles.

In addition, in the above vehicle construction, so-called underlays are advantageously applied between the exterior skin and corresponding roof arches, security elements or strengthening elements in order to prevent any vibration of the external skin and any knocking together of the individual components of the vehicle, as well to ensure the corresponding separation distances of the groups of components. The underlay can strengthen the vehicle structure, and these underlays sometimes have sealing or adhesive functions as well.

As a composition which integrates the function of vibration damping/soundproofing and the function of an underlay material as described above, Patent Literature 1 discloses a thermally curable composition comprising (a) an olefinic double bond-containing polymer or copolymer based on a diene and/or an aromatic substituted olefin, and (b) a vulcanization system. A cured material obtained from the thermally curable composition described in Patent Literature 1 has a vibration damping property to attenuate the vibration (for example, for attenuating vibrations of the car body of an automobile). In addition, when the composition described in Patent Literature 1 is used, because an acoustic attenuating compound and an underlay material, for which a plurality of different materials had to be used conventionally, are integrated, advantageous effects are attained such as the simplification of a production process, a production facility, and the like, and resultantly cost reduction. Further, this composition is a “pumpable” (that is, suitable for pump-coating (transportable)) material, and therefore can be applied by a robot, and can also be preferably used in a highly automated vehicle production process.

### CITATION LIST

### Patent Literature

Patent Literature 1: Japanese Patent Laid-Open No. 2012-529545

### SUMMARY OF INVENTION

### Technical Problem

A thermally curable composition is usually heated at a temperature in the range of about 160 to 180° C. for curing using an oven or the like. However, there are some cases that the temperature in the oven increases to higher temperature (for example, 190° C. or higher), and thus the thermally curable composition is exposed to the state of the so-called overbaking. The composition described in the above Patent Literature 1 has a problem that when it is overbaked at high temperature during curing, the decrease in strength is large, for example, the adhesive force of the cured product decreases.

Accordingly, it is an object of the present invention to provide a thermally curable composition having excellent vibration damping properties, and having a small decrease in strength even if heated at high temperature.

### Solution to Problem

The preferred embodiments of the present invention are as follows.

A thermally curable composition, comprising:
a component (a) comprising:

(a1) a solid rubber,

(a2) an olefinic double bond-containing polymer which is liquid or pasty at 22° C.,

(a3) a hydrocarbon resin in an amount of 0 to 22% by weight based on the total weight of the composition, and

(a4) a liquid polydiene; and
a component (b) comprising:

(b1) sulfur in an amount of 1 to 3% by weight based on the total weight of the composition, and

(b2) an organic vulcanizing agent in an amount of 0 to 0.2% by weight based on the total weight of the composition.

### Advantageous Effect of Invention

According to the present invention, it is possible to provide a thermally curable composition which provides a cured product having vibration damping properties, in which a decrease in strength due to high temperature curing is reduced.

### BRIEF DESCRIPTION OF THE DRAWINGS

FIG. 1(a) shows a cross-sectional view of a shear test piece used in measurements of ratios of decrease in strength by high temperature heating in Examples.

FIG. 1(b) shows a front view of a shear test piece used in measurements of ratios of decrease in strength by high temperature heating in Examples.

FIG. 2 is a graph showing the relationship between the loss factor (tan δ) of the cured material of the composition of Example 1 and temperature.

### DESCRIPTION OF EMBODIMENTS

A thermally curable composition of an embodiment of the present invention comprises:
a component (a) comprising:

(a1) a solid rubber,

(a2) an olefinic double bond-containing polymer which is liquid or pasty at 22° C.,

(a3) a hydrocarbon resin in an amount of 0 to 22% by weight based on the total weight of the composition, and

(a4) a liquid polydiene; and
a component (b) comprising:

(b1) sulfur in an amount of 1 to 3% by weight based on the total weight of the composition, and

(b2) an organic vulcanizing agent in an amount of 0 to 0.2% by weight based on the total weight of the composition.

A cured product which has vibration damping properties in a wide temperature region and in which a decrease in strength due to high temperature curing is reduced can be obtained from the thermally curable composition of the present invention. In the present specification, a cured product is also described as a “cured material.”

Here, the phrase that a cured product has vibration damping properties means that a cured product has inherent acoustic attenuation characteristics (vibration attenuation characteristics), and specifically means that a cured product has dissipative vibration attenuation characteristics which can convert mechanical vibration energy to heat. In such a cured material having vibration damping properties, the amplitude of vibrations which have started attenuates rapidly in a short time. The vibration damping properties of a cured material can be evaluated by measuring vibration attenuation behavior by a dynamic mechanical analysis (DMA) as described later.

The thermally curable composition, the cured material thereof, and use of them, and processes for producing them according to the present invention will be described in detail below.

In the present specification, a “thermally curable composition” is sometimes simply described as a “composition.” In addition, in description of the composition herein, an amount described by “%” represents % by weight based on the total weight of the composition unless otherwise specified. In the present specification, “average molecular weight” represents the mass average molecular weight of a polymer unless otherwise specified, and is specifically obtained by using gel permeation chromatography (GPC), and converting molecular weight using a calibration curve using polystyrenes having monodisperse molecular weight as standard materials.

### <Component (a): Resin Component>

### (a1) Solid Rubber

As the solid rubber (including a thermoplastic polymer which exhibits elastomer elasticity at room temperature (22° C.)) (a1), for example, solid rubbers based on polybutadiene, styrene butadiene rubbers (styrene/butadiene/styrene copolymers (SBS)), butadiene/acrylonitrile rubbers, styrene/isoprene rubbers (styrene/isoprene/styrene copolymers (SIS)), styrene-ethylene/propylene-styrene copolymers (SEPS), styrene-ethylene/ethylene/propylene-styrene copolymers (SEEPS), synthetic or natural isoprene rubbers, polycyclooctenamer, butyl rubbers, and polyurethane rubbers may be preferably used. These may be used alone, or in combination of two or more of these.

The molecular weight and the like of the solid rubber are not particularly limited as long as they are in ranges in which the solid rubber exhibits elastomer elasticity at room temperature (22° C.). For example, the Mooney viscosity (ML₁₊₄ (100° C.)) of the solid rubber is not particularly limited, but preferably in the range of 20 to 60, more preferably in the range of 30 to 50. The Mooney viscosity can be measured according to JIS K 6300.

Examples of the “solid rubbers based on polybutadiene” include butadiene homopolymers and copolymers comprising a monomer unit other than butadiene monomer (1,3-butadiene) in a small amount (for example, 10 mol % or less). Here, examples of the monomer unit other than butadiene monomer include conjugated dienes such as isoprene, 1,3-pentadiene, 2-ethyl-1,3-butadiene, 4-methylpentadiene, and 2,4-hexadiene; acyclic monoolefins such as ethylene, propylene, butene, and pentene; cyclic monoolefins such as cyclopentene, cyclohexene, and norbornene; and nonconjugated diolefins such as dicyclopentadiene and 1,5-hexadiene. In addition, the solid rubbers based on polybutadiene preferably have a high cis content, and preferably have a cis-1,4-double bond content of 80% or more, preferably greater than 85%.

In the present invention, the content of the solid rubber (a1) is not particularly limited, but is preferably 1.2% by weight or more, more preferably 1.5% by weight or more, based on the total amount of the composition. When the content of the solid rubber is 1.2% by weight or more, sagging properties can be ensured. In addition, the content of the solid rubber is preferably 8% by weight or less, more preferably 4% by weight or less. When the content of the solid rubber is 8% by weight or less, the vibration damping properties of the cured material can be maintained well.

(a2) Olefinic Double Bond-Containing Polymer which is Liquid or Pasty at 22° C. (Acoustic Attenuating Resin)

The olefinic double bond-containing polymer which is liquid or pasty at 22° C. functions so as to provide acoustic attenuation characteristics to the cured material. In the present specification, the “olefinic double bond-containing polymer which is liquid or pasty at 22° C. (a2)” is also referred to as an “acoustic attenuating resin,” or the “olefinic double bond-containing polymer (a2).”

The olefinic double bond-containing polymer (a2) is preferably liquid or pasty at room temperature (22° C.), and in addition, preferably has a glass transition temperature not far less than room temperature. Specifically, the glass transition temperature is preferably −30° C. or higher, more preferably −20° C. or higher, and is preferably 20° C. or lower, more preferably 15° C. or lower. Here, “liquid” means such a state that the polymer can be poured out of a container under influence of gravity, and “pasty” means such a state that the polymer can be smoothed out to a flat uniform layer. In addition, in the present specification, the glass transition temperature means a value measured according to JIS K 6240 using “differential scanning calorimetry (DSC).” The polymer may be a homopolymer or a copolymer.

The olefinic double bond-containing polymer (a2) is preferably a polymer of a diene and/or an aromatic substituted olefin, and is more preferably a copolymer of styrene and a diene from the viewpoint of improving the vibration damping properties of the cured material. The diene can be selected from butadiene, isoprene, and a combination thereof. The copolymer of styrene and a diene preferably has a styrene content of 10% by weight or more, more preferably 15% by weight or more, and preferably has a styrene content of 60% by weight or less, more preferably 50% by weight or less. When the styrene content is in the above range, excellent dissipative vibration attenuation characteristics (that is, the characteristic of converting mechanical vibration energy to heat) can be achieved.

A “copolymer” means all polymers composed of two or more different monomers. Configuration of comonomers present in the copolymer is arbitrary. The copolymer may be a block copolymer or a random copolymer, but is more preferably a random copolymer from the viewpoint of providing vibration damping properties.

In one embodiment of the present invention, the above olefinic double bond-containing polymer (a2) is preferably a block copolymer of styrene and diene.

In another embodiment of the present invention, the above olefinic double bond-containing polymer (a2) is preferably a random copolymer of styrene and diene.

The diene component may be unsubstituted or substituted, and examples of the substituent include carboxyl group, hydroxy group, and amino group. When the diene component has a substituent, the adhesiveness of the composition to a metal substrate can be improved in some cases.

The positions of olefinic double bonds formed in the polymer chain by polymerization of the diene are not particularly limited, but from the viewpoint of vulcanization properties and acoustic attenuation behavior, the olefinic double bond-containing polymer (a2) is formed so that it comprises an unsaturated diene fraction, and the ratio of the vinyl fraction in this diene fraction (that is, the ratio of 1,2 vinyl bonds to all olefinic double bonds) is preferably 20 mol % or more, more preferably 40 mol % or more, and is preferably 98 mol % or less, more preferably 90 mol % or less, and further preferably 80 mol % or less.

In another embodiment, the olefinic double bond-containing polymer (a2) is formed so that it comprises an unsaturated diene block fraction, and the ratio of the vinyl fraction in this diene block fraction (that is, the ratio of 1,2 vinyl bonds to all olefinic double bonds) is preferably 20 mol % or more, more preferably 40 mol % or more, and is preferably 90 mol % or less, more preferably 80 mol % or less.

The mass average molecular weight of the olefinic double bond-containing polymer (a2) is not particularly limited, but is preferably 1,000 or more, more preferably 2,000 or more, and further preferably 5,000 or more, and is preferably 50,000 or less, more preferably 35,000 or less, and further preferably 25,000 or less. The olefinic double bond-containing polymer (a2) particularly preferably has a mass average molecular weight in the range of 5,000 to 18,000. The olefinic double bond-containing polymer (a2) preferably has the above structure and the above mass average molecular weight.

The olefinic double bond-containing polymers (a2) may be used alone, or in combination of two or more.

The content of the olefinic double bond-containing polymer (a2) is preferably 5% by weight or more, more preferably 7% by weight or more, based on the total weight of the composition in order to obtain sufficient vibration damping performance. In addition, the content of the olefinic double bond-containing polymer (a2) is preferably 15% by weight or less, more preferably 12% by weight or less, based on the total weight of the composition in order to maintain strength.

### (a3) Hydrocarbon Resin

The hydrocarbon resin (a3) contributes to setting the glass transition temperature of the cured material in the desired range of −5° C. to 40° C. Thus, the cured material exhibits excellent acoustic attenuation characteristics in a wide temperature range including usual ambient temperature. The content of the hydrocarbon resin is preferably 0 to 22% by weight based on the total weight of the composition, and the lower limit is more preferably 3% by weight or more, further preferably 5% by weight or more, and the upper limit is more preferably 20% by weight or less, further preferably 15% by weight or less. When the composition comprises the hydrocarbon resin, the cured material exhibits vibration damping properties as described above, and when the content is 22% by weight or less, decrease in strength of the cured material when the composition is heated at high temperature can be suppressed.

The hydrocarbon resins can be totally aliphatic or totally aromatic or they can possess aliphatic and aromatic structures. Moreover, they can be aromatically modified aliphatic resins. In each case, the hydrocarbon resin particularly preferably has compatibility with other polymer components.

Examples of the hydrocarbon resins include natural hydrocarbon resins such as terpene resins (for example, terpene resins, hydrogenated terpene resins, and aromatic modified terpene resins) and rosin resins (for example, rosins and modified rosins such as hydrogenated rosins, disproportionated rosins, and polymerized rosins); and synthetic hydrocarbon resins such as petroleum hydrocarbon resins, coumarone-indene resins, xylene resins, and styrene resins, and among them, petroleum hydrocarbon resins are preferred.

For the petroleum hydrocarbon resins, petroleum hydrocarbon resins obtained by polymerizing a fraction containing an unsaturated hydrocarbon monomer produced as a by-product by thermal cracking of petroleum naphtha or the like can be preferably used, and specific examples of the petroleum hydrocarbon resins include C5 aliphatic petroleum resins, C9 aromatic petroleum resins, C5/C9 petroleum resins, and hydrogenated petroleum resins obtained by hydrogenating C9 or C5/C9 petroleum resins, and alicyclic petroleum resins such as dicyclopentadiene petroleum resins.

Examples of a commercial product preferably used as the hydrocarbon resin include Escorez (trademark) 1102, Escorez (trademark) 2173, Escorez (trademark) 2184, Escorez (trademark) 2101, Escorez (trademark) 2105, Novares (trademark) TK, Novares (trademark) TV, Novares (trademark) TA, Novares (trademark) TP, Novares (trademark) TR, Novares (trademark) TS, Nova (trademark) TW, and Nevtac (trademark) 10. These may be used alone, or in combination of two or more of these.

By blending resins preferably having a softening point exceeding 10° C. (>10° C.), more preferably having a softening point exceeding 40° C. (>40° C.), and furthermore preferably having a softening point exceeding 70° C. (>70° C.), which have compatibility with other polymer components, as the hydrocarbon resin (a3), into the composition at a predetermined ratio, the glass transition temperature of the cured material can be adjusted in the desired range of −5° C. to 40° C. and increase the maximum value of the loss factor (tan δ). In addition, the softening point of the hydrocarbon resin is not particularly limited, but is preferably 140° C. or less. Here, the softening point is a value according to JIS K 2207.

### (a4) Liquid Polydiene

The liquid polydiene (a4) is preferably a polydiene which is liquid at room temperature (22° C.).

Examples of the diene monomer of the liquid polydienes include butadiene, isoprene, and chloroprene, and examples of the polydiene include homopolymers or copolymers of these and hydrogenated materials thereof. Among them, preferred polydienes are polybutadiene, polyisoprene, and the like, and particularly preferred is polybutadiene.

In addition, for the liquid polydiene, one having functional groups in main and/or side chain is also effective. Examples of the functional groups include carboxyl group, hydroxy group, and amine group, and the liquid polydiene may contain two or more functional groups in combination. From the viewpoint of adhesiveness to a metal substrate, the liquid polydiene preferably comprises carboxyl group. The functional group should be present in at least one of the main chain and side chain, and may be present at any position, for example, at the end of chain or in the middle of chain in the main chain or the side chain, but is preferably present at at least the end of chain.

The liquid polydiene compound preferably has a mass average molecular weight in the range of 500 to 50,000, more preferably in the range of 1000 to 10,000. In addition, the liquid polydiene preferably has a glass transition temperature of less than −30° C.

The content of the liquid polydiene (a4) is preferably 3% by weight or more, more preferably 5% by weight or more, based on the total amount of the composition. In addition, the content of the liquid polydiene is preferably 20% by weight or less, more preferably 10% by weight or less, based on the total amount of the composition. When the composition comprises the liquid polydiene (a4) in an amount of 3% by weight or more and 20% by weight or less, the vibration damping properties and adhesiveness of the cured material obtained from the composition are likely to be improved.

### <Component (b): Vulcanization System Component>

The composition according to the present invention comprises (b1) sulfur (which means sulfur as a simple substance) in an amount of 1 to 3% by weight based on the total weight of the composition, and (b2) an organic vulcanizing agent in an amount of 0 to 0.2% by weight based on the total weight of the composition, as a vulcanization system component. While the organic vulcanizing agent may be blended into the composition as a mixture of an active component (that is, a compound having a vulcanization effect) and a compound other than the active component, “the content of the organic vulcanizing agent” in the present invention means the content of only the effective component. When the content of sulfur and the content of the organic vulcanizing agent in the composition are in the above ranges respectively, the cured material has sufficient adhesive strength, and decrease in strength when the composition is cured by high temperature heating can be suppressed.

For the sulfur, powdery sulfur is preferably used. The content of sulfur is preferably 1 to 3% by weight based on the total amount of the composition. When the content of sulfur is 1% by weight or more, the adhesiveness of the cured material increases, and when the content is 3% by weight or less, decrease in strength of the cured material cured by high temperature heating can be suppressed. The lower limit of the content of sulfur based on the total amount of the composition is preferably 1.2% by weight or more, more preferably 1.5% by weight or more, and further preferably 1.8% by weight or more, and the upper limit is preferably 2.8% by weight or less, more preferably 2.5% by weight or less.

The vulcanization system preferably comprises a vulcanization accelerator (also simply described as an “accelerator”) in addition to sulfur. Examples of the accelerator include organic accelerators such as dithiocarbamates (in the form of ammonium salts or metal salts), xanthogenates, thiuram compounds (monosulfides and disulfides), thiazole compounds, aldehyde/amine accelerators (for example, hexamethylenetetramine), and guanidine accelerators. Dibenzothiazyl disulfide (MBTS), 2-mercaptobenzothiazole (MBT), the zinc salt thereof (ZMBT), zinc dibenzyldithiocarbamate (ZBEC), N-cyclohexylbenzodithiazyl sulfenamide (CBS), and diphenylguanidine are particularly preferred. The content of such the accelerator, or in case a zinc compound is contained as described later, the total content of the accelerator and the zinc compound is preferably 0.25% by weight or more and 30% by weight or less, further preferably 0.8% by weight or more and 20% by weight or less, based on the total amount of the composition. In addition, in order to achieve particularly high thermal stability and reversion strength of the adhesive, the vulcanization system can also contain a bifunctional crosslinking agent. Specific examples thereof include crosslinking agents based on bifunctional dithiocarbamates, for example, 1,6-bis(N,N-dibenzylthiocarbamoyldithio)hexane. Such a crosslinking agent may be contained in an amount of 0 to 2% by weight, preferably 0 to 1% by weight, based on the total amount of the composition.

In addition, a zinc compound other than the above can also be used as the accelerator. Examples of the zinc compound which acts as the accelerator include zinc salts of fatty acids, zinc dithiocarbamate, basic zinc carbonate, and zinc oxide. The zinc oxide is preferably pulverized. The content of the zinc compound is preferably in the range of 0 to 10% by weight, more preferably 0.2 to 8% by weight, and further preferably 0.5 to 7% by weight, based on the total amount of the composition. These zinc compounds can be used in combination with the above-described accelerator, and are more preferably used in combination with the above-described accelerator in some cases. Further, another usual rubber vulcanization aid, for example, a fatty acid (for example, stearic acid), may be present in the composition.

The content of the organic vulcanizing agent in the composition of the present invention is preferably 0 to 0.2% by weight, more preferably 0 to less than 0.2% by weight, based on the total weight of the composition, and the composition further preferably does not comprise (that is, 0% by weight) the organic vulcanizing agent. The inventors of the present invention have found that when the vulcanization system in the thermally curable composition comprises the organic vulcanizing agent in an amount of 0.2% by weight or less, and sulfur in a predetermined amount, based on the total weight of the composition, decrease in strength of the cured material cured by heating at high temperature can be suppressed. Particularly when the composition of the present invention does not comprise an organic vulcanizing agent conventionally used in a thermally curable composition, decrease in strength of the cured material due to high temperature heating (overbaking) can be suppressed.

Examples of the organic vulcanizing agent include peroxide vulcanization systems and disulfide vulcanization systems.

Examples of the peroxide vulcanization systems include known organic peroxides which can be added as vulcanization systems. Examples of the peroxide vulcanization systems include crosslinking agents such as dibenzoyl peroxide, tert-butyl peroxybenzoate, and particularly, 1,1-di-(tert-butylperoxy)3,3,5-trimethylcyclohexane, butyl 4,4-di-(tert-butylperoxy)valeriate, dicumyl peroxide, di-(2-tert-butylperoxyisopropyl)benzene, tert-butyl cumyl peroxide, 2,5-dimethyl-2,5-di-(tert-butylperoxy)hexane, di-tert-butyl peroxide, 2,5-dimethyl-2,5-di-(tert-butylperoxy)hex-3-yne, and triallyl isocyanurate. Examples of the disulfide vulcanization systems, that is, vulcanization systems based on disulfides, include thiuram disulfide.

Examples of the organic vulcanizing agent also include other vulcanization systems other than the above. Examples of the other vulcanization systems include quinones, quinone dioximes, nitrosobenzene, and dinitrosobenzene (particularly p-dinitrosobenzene). These are also known as vulcanization systems for rubbers. Examples of the quinone dioximes include p-benzoquinone dioxime.

In one embodiment of the composition of the present invention, the following additives such as blowing agent, filler, and moisture absorbent, and plasticizer, and the like may be used in combination with the above-described essential components.

### <Component (c): Blowing Agent>

In one embodiment of the present invention, the composition may comprise a blowing agent so as to expand (foam) irreversibly before or during thermal curing, and preferably comprises (c1) a physical blowing agent in an amount of 0 to 3% by weight based on the total weight of the composition, and (c2) a chemical blowing agent in an amount of 0 to 0.2% by weight based on the total weight of the composition. The irreversible expansion of the blowing agent causes an irreversible volume increase that enables cavities or intermediate spaces to be more completely filled up with the cured compound

The content of the (c1) physical blowing agent in the composition is not particularly limited, but is preferably 0 to 3% by weight, more preferably 0.1% by weight to 2.5% by weight, and further preferably 0.2% by weight to 2.0% by weight, based on the total weight of the composition.

As the “physical blowing agent,” resin blowing agents which expand by heat (thermally expandable resin blowing agents) are preferred, and foamable plastic hollow microspheres which expand by heat are more preferred. Examples of the thermally expandable resin blowing agents include those based on polyvinylidene chloride copolymers or acrylonitrile/(meth)acrylate copolymers. These are commercially available, for example, under the name of “Dualite (registered trademark)” or “Expancel (registered trademark)” from Pierce & Stevens and Casco Nobel respectively.

Examples of the “chemical blowing agent” include those which emit gases by decomposition, and include azobisisobutyronitrile, azodicarbonamide, dinitrosopentamethylenetetramine, 4,4′-oxybis(benzenesulfonic acid hydrazide), diphenylsulfone-3,3′-disulfohydrazide, benzene-1,3-disulfohydrazide, and p-toluene sulfonyl semicarbazide.

The content of the (c2) chemical blowing agent in the composition is preferably 0 to 0.2% by weight, more preferably 0 to less than 0.2% by weight, based on the total weight of the composition, and the composition further preferably does not comprise (that is, 0% by weight) the (c2) chemical blowing agent. The inventors of the present invention have found that when the content of a chemical blowing agent usually used as a blowing agent in a thermally curable composition is preferably 0.2% by weight or less, more preferably less than 0.2% by weight, and the composition further preferably does not comprise the chemical blowing agent, decrease in strength of the composition due to high temperature curing can be suppressed. Thus, when the composition of the present invention comprises a blowing agent, particular preference is given to such an aspect that the composition comprises a physical blowing agent and does not comprise a chemical blowing agent.

In the present embodiment, whether a blowing agent is used or not can be appropriately selected according to use of the composition, and the like. For example, in use for manufacturing of vehicles, it is effective that the composition foams during a baking-curing step to reduce the strain in the external skin, and therefore a blowing agent is desirably added in a suitable range.

### <Component (d): Filler>

The composition of the present invention may contain a filler (d). The content of the filler is not particularly limited, but based on the total amount of the composition, the lower limit is preferably 10% by weight or more, more preferably 15% by weight or more, and further preferably 25% by weight or more, and the upper limit is preferably 50% by weight or less, more preferably 45% by weight or less, further preferably 40% by weight or less, and still further preferably 36% by weight or less.

The filler can be selected from various substances, and examples of the filler include chalk, natural or ground calcium carbonate, calcium magnesium carbonate, silica, talc, mica, and barite. In one embodiment, it can be advantageous for at least some of the fillers to be surface-treated. For example, in order to decrease moisture taken in the cured material, and in order to decrease the moisture sensitivity of the cured material, the filler is preferably coated with stearic acid, and examples thereof include calcium carbonate and chalk coated with stearic acid. In addition, in one embodiment, a filler having a high aspect ratio, for example, a flaky filler having a thickness which is small compared with the size of the flake surface, can be preferably used. As the flaky filler, fillers having an aspect ratio of 10 or more (that is, the thickness in the direction perpendicular to the flake surface is 1/10 or less of the minimum area of the flake surface), for example, layered silicates (preferably mica and talc) and graphite, are preferred from the viewpoint of providing good acoustic attenuation characteristics. Use of general inorganic lightweight aggregate (glass balloons, ceramic balloons, and the like) for adjusting specific gravity is also possible.

(Moisture Absorbent)

The composition of the present invention may further contain calcium oxide in an amount of 0 to 8% by weight, preferably 1 to 6% by weight, and more preferably 1.5 to 5.5% by weight, based on the total amount of the composition, in addition to the above filler, for binding moisture.

In addition, the composition of the present invention may comprise carbon black. The content of the carbon black is preferably 0.1% by weight or more, more preferably 0.3% by weight or more, and is preferably 3% by weight or less, more preferably 2% by weight or less, based on the total weight of the composition.

### <Component (e): Plasticizer>

The composition of the present invention may further comprise a plasticizer (e). When the composition comprises the plasticizer, it is possible to improve the processability of the composition, and improve the mechanical characteristics of the cured material.

The content of the plasticizer is not particularly limited, but is generally 40% by weight or less, preferably 30% by weight or less, and more preferably 25% by weight or less, and is preferably 2% by weight or more, more preferably 5% by weight or more, based on the total amount of the composition.

Examples of the plasticizer include phthalic acid esters, hydrocarbon oils, for example, white oils, and natural oils which are liquid at 22° C. (for example, fatty acid glycerin esters such as the so-called triglycerides, for example, rapeseed oil, soybean oil, walnut oil, linseed oil, sunflower oil, and olive oil).

Particularly, by containing the plasticizer and the above-described hydrocarbon resin (a3) in the composition, the acoustic attenuation characteristics can be more improved at a temperature in the range of −5° C. to 40° C.

The composition of the present invention may further comprise a reinforcing filler. Preferred examples of the reinforcing filler include reinforcing fillers based on aramid fibers, carbon fibers, glass fibers, polyamide fibers, polyurethane fibers, or polyester fibers. These fibers are preferably short fibers which are in the form of pulp fibers or staple fibers. These fibers preferably have an average fiber length of 100 to 250 μm and a diameter of 5 to 20 μm. Here, the fiber length of the longest fiber preferably does not exceed 1000 to 2000 μm. Here, glass fibers, aramid fiber-type polyamide fibers, and further polyester fibers are particularly preferred. The fiber content of the composition is not particularly limited, but is preferably 0.5 to 10% by weight based on the total amount of the composition.

The composition of the present invention comprises the above-described component (a) and component (b), and further, preferably comprises at least one selected from the group consisting of the (c) blowing agent, the (d) filler, and the (e) plasticizer, and more preferably comprises all of the (c) blowing agent, the (d) filler, and the (e) plasticizer.

Examples of preferred aspects of components constituting the thermally curable composition of the present invention are shown in Table 1, but the present invention is not limited to these.

TABLE 1

| | Amount to be blended | |
|---|---|---|
| | | (More |
| | (Preferred | preferred |
| Component | embodiment) | embodiment) |
| (a) Resin component | | |
| (a1) Solid rubber | 1.2-8 | 1.5-4 |
| (a2) Acoustic attenuating resin | 5-15 | 7-12 |
| (a3) Hydrocarbon resin | 0-22 | 5-20 |
| (a4) Liquid polydiene | 3-20 | 5-10 |
| (b) Vulcanization System | | |
| (b1) Sulfur | 1-3 | 1.5-2.5 |
| Vulcanization accelerator (MBTS, MBT, | 0.25-20 | 0.8-12 |
| ZMBT, ZBEC, CBS, etc.) | | |
| (b2) Organic vulcanizing agent | 0-0.2 | 0 |
| | (Active | |
| | component) | |
| Zinc oxide | 0-8 | 0.5-7 |
| (c) Blowing agent | | |
| Chemical blowing agent | 0-0.2 | 0 |
| Physical blowing agent | 0-3 | 0.2-2 |
| (d) Filler | | |
| Calcium carbonate, graphite and silicate- | 15-50 | 25-45 |
| based fillers e.g. talc, mica, ceramic | | |
| balloons, silica, etc. | | |
| Carbon black | 0.1-3 | 0.3-2 |
| Calcium oxide (moisture absorbent) | 1-6 | 1.5-5.5 |
| Antioxidant | 0.1-1.0 | 0.2-0.7 |
| (e) Plasticizer | 2-30 | 5-25 |

(Amounts are given in % based on the total weight of the composition.)

The composition of the present invention is not limited to the compositions described in the above Table 1, and the amounts of the components blended may be changed, and the composition can contain fibers, another typical vulcanization accelerator and/or crosslinking agent, another antioxidant, coactivator, catalyst, oil, resin, anti-aging agent, rheological aid, adhesion accelerator, pigment, thermoplastic polymer, and/or the like, in addition to the components illustrated above, or in place of any of the components illustrated above.

The composition of the present invention can be produced, for example, by introducing the above-described components into a mixing machine such as a bead mill, a grinding machine, a pot mill, a three-roll mill, a rotary mixer, or a twin screw mixer, and mixing them.

The composition of the present invention is a mixture of a plurality of components which are liquid or solid at 22° C., and an advantage of the composition is that the mixing ratio of the components can be appropriately adjusted in the range which does not impair the effect of the present invention. Therefore, in one embodiment of the present invention, the ratio of the components can be adjusted so that the composition can be subjected to mechanical coating (for example, by a robot) or manual coating at a temperature of 60° C. or less by using standard coating apparatuses for adhesives and sealants in the automobile industry. For this, it is preferred that the above-described acoustic attenuating resin is liquid or pasty at 22° C., and as described in detail above, the solid rubber, the acoustic attenuating resin, the hydrocarbon resin, and the liquid polydiene are blended at a preferred ratio. Therefore, a composition according to a preferred embodiment of the present invention is characterized in that the composition preferably has such a viscosity at a temperature in the range of 15 to 60° C. that the composition can be pumped with a pump (a rotary pump, a gear pump, or a lift piston pump). According to the present embodiment, advantages are that it is not necessary to use a particular extrusion technique, and it is not necessary to previously make an injection-molded article or the like.

Another aspect of the present invention relates to a coating method of the composition of the present invention. Therefore, the present invention relates to a process for applying the composition of the present invention, the process comprising injecting the composition of the present invention by a pump (for example, the above-described pump) to the point of application at a temperature in the range of 15 to 60° C., whereby applying the composition in a liquid or pasty state onto a lubricated substrate, an untreated substrate, or a clean substrate.

After the application, the composition according to the present invention can be thermally cured, for which the ovens that are typically available in the industrial segment of vehicle construction and equipment construction for baking paint coatings can be used. The activation temperature for the thermal curing and the optional foaming is preferably in the range of 160 to 220° C. This temperature is preferably maintained for a period of 10 to 60 minutes.

Besides the composition of the present invention used in pump application, a formed article that is the baked and cured material of the composition of the present invention can be used as a retrofit part in a trim shop (rigging step), an aftermarket (repair market), or the like.

Another aspect of the present invention relates to a cured product (cured material) obtained by curing the composition according to the present invention. The cured material according to the present embodiment has excellent vibration damping properties (acoustic attenuation characteristics), and a small decrease in strength by heating at high temperature.

In the present embodiment, the cured material preferably has a glass transition temperature in the range of −5 to 40° C., preferably in the range of 0 to 30° C. When the glass transition temperature is in the above range, good vibration damping properties (acoustic attenuation behavior) are attained in a wide temperature range. The glass transition temperature of the cured material can be defined as the temperature at which the loss factor (tan δ) is the maximum.

In addition, in the present embodiment, the minimum value of the loss factor (tan δ) (measurement frequency 50 Hz) of the cured material at a temperature in the range of 0 to 40° C. is preferably 0.2 or more. In addition, in one embodiment of the present invention, the loss factor (tan δ) (measurement frequency 50 Hz) of the cured material at a temperature in the range of 20 to 40° C. is preferably 0.5 or more, more preferably 0.8 or more. When the loss factor (tan δ) value is in the above range, good acoustic attenuation characteristics can be exhibited in a wide temperature range.

In the present specification, the loss factor (tan δ) of the cured material is a value measured by a dynamic mechanical analysis (DMA) according to JIS K 6394 as follows:

Measurement sample: the cured material (curing conditions: maintained for 20 minutes at 170° C.)

Measurement equipment: an apparatus adaptable to JIS K 6394
(DMS6100 manufactured by SII (Seiko Instruments Inc.), or the like)

Measurement mode: compression

Measurement temperature: −20° C. to 80° C.

Rate of temperature increase: 2° C./min

Measurement frequency: 0.1 to 100 Hz

Selected frequency in loss factor (tan δ) and glass transition temperature measurement: 50 Hz

The cured product according to the present embodiment can be produced by heating the composition of the present invention, for example, at a temperature in the range of 160 to 220° C. for 10 to 60 minutes. Here, the composition may be directly applied to the site of use before cured, or may be processed to form a baked and cured product used as a retrofit part. In addition, a known molding process such as injection molding can also be used.

Another aspect of the present invention relates to use of the composition according to the present invention and the cured material thereof. The composition of the present invention can be preferably used as an underlay material and an adhesive/sealant, particularly for structural attachments (for example, doors, engine hoods and trunk lids, roofs, fronts, and chassis portions), and further, in the passenger compartments of vehicles (automobiles, buses, and the like), and for production of railcars. Further, the composition of the present invention can also be preferably used in equipment construction when acoustic vibrations that can emanate from motors, gears or pumps (generally from vibrations generated by rotating machines) should be attenuated. Therefore, the present invention relates to use of the composition of the present invention as an acoustic attenuating material and an underlay material in vehicle and equipment construction.

### EXAMPLES

The present invention will be described in more detail below by Examples, but the present invention is not limited to these examples.

Respective components were mixed in amounts described in Table 2 to prepare the compositions of Examples 1 to 5 and Comparative Examples 1 to 5. Further, the ratio of decrease in strength when each of the prepared compositions was thermally cured at high temperature, and the dynamic viscoelasticity of a cured material obtained by thermal curing were evaluated as follows.

### <Measurement of Ratio of Decrease in Strength by Heating at High Temperature>

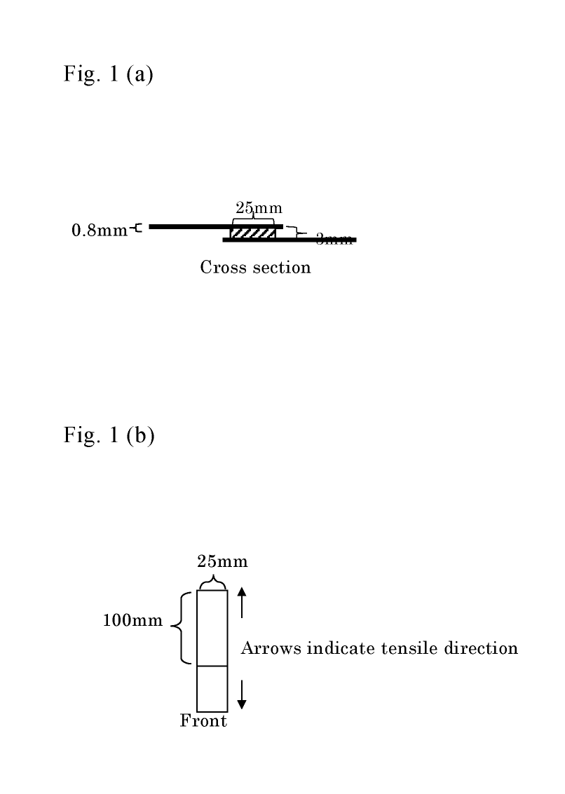

After SPCC steel plates having a thickness of 0.8 mm and a size of 100×25 mm were washed, an antirust oil was applied, and the composition was applied with 25×25×3 mm thickness to make a shear test piece as shown in FIGS. 1(a) and 1(b). FIG. 1(a) is a cross-sectional view of a shear test piece, and FIG. 1(b) is a front view. This shear test piece was baked under the conditions at 170° C. maintained for 20 minutes (initial stage), and maintained at 190° C. for 20 minutes/maintained at 200° C. for 20 minutes/maintained at 210° C. for 20 minutes/maintained at 220° C. for 20 minutes (overbaking).

In the test, a general tensile tester was used, and the moving speed of the clamp was 50 mm/min. The ratio of decrease in strength after overbaking with respect to initial strength was obtained by the following equation:

A=100×(1−B/C)

wherein A represents the ratio of decrease in strength (%), B represents shear strength (MPa) after overbaking, and C represents initial shear strength (MPa).

The ratios of decrease in strength of the compositions of the Examples and the Comparative Examples at each temperature are shown in Table 2. In Table 2, the units of numerical values regarding the component (blend) of the composition are all % by weight based on the total amount of the composition, and the unit of the strength decrease ratio A is %. A composition having a ratio of decrease in strength within 30% in all cases of heating at a temperature in the range of 190° C. to 220° C. was determined as accepted, and a composition having a ratio of decrease in strength exceeding 30% at any temperature was evaluated as rejected.

### <Evaluation of Dynamic Viscoelasticity>

The method of measuring the loss factor (tan δ) of a cured material will be described below.

1. A specimen composition was applied to a steel plate so as to have a diameter of 50 to 60 mm and a thickness of 4 to 8 mm, and maintained for 20 minutes at 170° C. for curing.

2. The cured specimen was formed into a circular shape having a diameter of 7 to 10 mm and a thickness of 4 to 8 mm.

3. The loss factor (tan δ) of the above shaped specimen at each measurement frequency was measured according to the following measurement conditions:

### (Measurement Conditions)

Measurement equipment: DMS6100 manufactured by SII (Seiko Instruments Inc.)

Measurement mode: compression

Measurement temperature: −20° C. to 80° C.

Temperature increase condition: 2° C./min

Measurement frequency: 0.1, 1.0, 10, 20, and 50 Hz

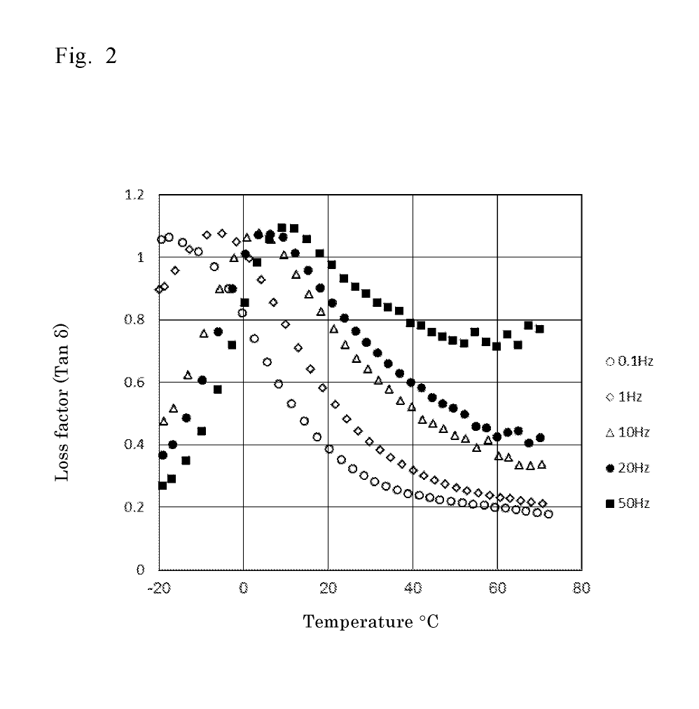

For the cured material of the thermally curable composition of Example 1, the results of measurement of tan δ at each measurement frequency are shown in FIG. 2.

TABLE 2

| | | Examples | | | | | Comparative Examples | | | | |
|---|---|---|---|---|---|---|---|---|---|---|---|
| Component | Materials | 1 | 2 | 3 | 4 | 5 | 1 | 2 | 3 | 4 | 5 |
| (a) Resin component | | | | | | | | | | | |
| (a1) Solid rubber | High cis-1,4-polybutadiene (Mooney | 1.9 | 2 | 1.9 | 2 | 1.9 | 1.9 | 2.5 | 2 | 1.6 | 1.9 |
| | viscosity 40 (ML₁₊₄100° C.)) | | | | | | | | | | |
| (a2) Acoustic | Polystyrene/polybutadiene | 5.7 | 10 | 5.2 | 5.7 | 5.7 | 5.7 | 5 | 10 | 10 | 5.7 |
| attenuating resin | random copolymer | | | | | | | | | | |
| | (Tg: −6° C., styrenecontent: | | | | | | | | | | |
| | 40 wt %, Mw: 10000 g/mol) | | | | | | | | | | |
| (a3) Hydrocarbon resin | Aromatic Hydrocarbon Resin | 11 | 5 | 22 | 11 | 10 | 23 | 11 | 15 | 10 | 15 |
| | (softening temperature 90° C.) | | | | | | | | | | |
| (a4) Liquid polydiene | Active carboxyl group- | 7.6 | 7 | 6 | 7.6 | 6.5 | 7.6 | 6 | 10 | 8 | 7.6 |
| | containing polybutadiene | | | | | | | | | | |
| | (Molecular weight: | | | | | | | | | | |
| | 1000~10000 g/mol) | | | | | | | | | | |
| (b) Vulcanization System | | | | | | | | | | | |
| (b1) Sulfur | Sulfur | 2 | 1.8 | 2.5 | 2 | 2 | 2 | 1.5 | 3.2 | 0.9 | 2 |
| (b2) Organic vulcanizing | p-benzoquinone dioxime | 0 | 0 | 0 | 0.2 | 0 | 0 | 0.3 | 0 | 0 | 0 |
| agent | (as active component) | | | | | | | | | | |
| Vulcanization | zinc dibenzyldithio- | 2.5 | 3.5 | 2.5 | 2.5 | 2.5 | 2.5 | 2.5 | 2.5 | 3.5 | 2.5 |
| accelerator | carbamate | | | | | | | | | | |
| | Zinc oxide | 1.4 | 0 | 1.4 | 1.4 | 1.4 | 1.4 | 1.1 | 1.1 | 1.1 | 1.4 |
| (c) Blowing agent | | | | | | | | | | | |
| (c1) Physical | Thermal plastic polymer | 0.2 | 2 | 0 | 0.2 | 0.2 | 0.2 | 0.6 | 0 | 1 | 0.2 |
| blowing agent | shell of acrylic copolymer | | | | | | | | | | |
| | encapsulating liquid | | | | | | | | | | |
| | hydrocarbon having | | | | | | | | | | |
| | low boiling point | | | | | | | | | | |
| (c2) Chemical | 4,4'-oxybis(benzenesulfonic | 0 | 0 | 0 | 0 | 0.2 | 0 | 0 | 0 | 0 | 0.3 |
| blowing agent | acid hydrazide) | | | | | | | | | | |
| (d) Filler | Mixture of calcium | 42 | 43 | 36 | 41 | 44 | 33 | 42 | 38 | 46 | 39 |
| | carbonate powder and | | | | | | | | | | |
| | silicate-based filler | | | | | | | | | | |
| | (silicate-based filler: | | | | | | | | | | |
| | about 10 wt % of | | | | | | | | | | |
| | composition) | | | | | | | | | | |
| | Carbon black | 0.2 | 0.2 | 0.2 | 0.2 | 0.2 | 0.2 | 0.2 | 0.2 | 0.2 | 0.2 |
| (e) Plasticizer | Diisononyl phthalate | 23 | 23 | 20 | 23 | 22 | 20 | 24 | 15 | 15 | 22 |
| Antioxidant | poly(dicyclo- | 0.2 | 0.2 | 0.2 | 0.4 | 0.5 | 0.2 | 0.2 | 0.6 | 0.6 | 0.2 |
| | pentadiene-co-p-cresol) | | | | | | | | | | |
| Others | Calcium oxide | 2.3 | 2.3 | 2.1 | 2.8 | 2.9 | 2.3 | 3.1 | 2.4 | 2.1 | 2.0 |
| Evaluation | | | | | | | | | | | |
| | Heating temperature and | | | | | | | | | | |
| | maintained period | | | | | | | | | | |
| Initial (normal | At 170° C. x maintained | cured | cured | cured | cured | cured | cured | cured | cured | No | cured |
| heating) | for 20 min | | | | | | | | | curing | |
| Ratio (A) of | At 190° C. x maintained | 10 | 5 | 20 | 25 | 25 | 30 | 40 | 40 | — | 45 |
| decrease in strength | for 20 min | | | | | | | | | | |
| by heating to initial | At 200° C. x maintained | 10 | 5 | 20 | 25 | 25 | 35 | 40 | 45 | — | 50 |
| adhesive shear | for 20 min | | | | | | | | | | |
| strength | At 210° C. x maintained | 15 | 5 | 25 | 30 | 30 | 35 | 50 | 45 | — | 55 |
| | for 20 min | | | | | | | | | | |
| | At 220° C. x maintained | 20 | 10 | 30 | 30 | 30 | 40 | 50 | 50 | — | 60 |
| | for 20 min | | | | | | | | | | |

As shown in Table 2, for the compositions of Examples 1 to 5, the ratios of decrease in strength due to heating at a temperature in the range of 190° C. to 220° C. were all 30% or less. On the other hand, Comparative Example 1 has a hydrocarbon resin content as high as 23% by weight, and therefore has a large ratio of decrease in adhesive force, that is, a large ratio of decrease in strength, when heated at 200° C. or more. Comparative Example 2 contains the organic vulcanizing agent in an amount of 0.3% by weight, and therefore has a large ratio of decrease in strength when heated at 190° C. or more. Comparative Example 3 has a sulfur content as high as 3.2% by weight, and therefore has a large ratio of decrease in strength when heated at 190° C. or more. Comparative Example 4 has a sulfur content as low as 0.9% by weight, and therefore could not be cured during usual heating, and the ratio of decrease in strength could not be measured. Comparative Example 5 contains the chemical blowing agent in an amount of 0.3% by weight as the blowing agent, and therefore has a large ratio of decrease in strength when heated at 190° C. or more.

In addition, as shown in FIG. 2, for the cured material obtained from the thermally curable composition of Example 1, a good tan δ value is maintained in a wide temperature range.

### INDUSTRIAL APPLICABILITY

The present invention can be utilized in all industrial fields which require materials having excellent vibration damping properties, and a small ratio of decrease in strength due to high temperature curing. The composition according to the present invention can be particularly effectively utilized in the automobile and equipment construction industries.

1. A thermally curable composition, comprising:
a component (a) comprising:
(a1) a solid rubber,
(a2) an olefinic double bond-containing polymer which is liquid or pasty at 22° C.,
(a3) a hydrocarbon resin in an amount of 0 to 22% by weight based on the total weight of the composition, and
(a4) a liquid polydiene; and
a component (b) comprising:
(b1) sulfur in an amount of 1 to 3% by weight based on the total weight of the composition, and
(b2) an organic vulcanizing agent in an amount of 0 to 0.2% by weight based on the total weight of the composition.

2. The thermally curable composition according to claim 1, further comprising a component (c) comprising:
(c1) a physical blowing agent in an amount of 0 to 3% by weight based on the total weight of the composition, and
(c2) a chemical blowing agent in an amount of 0 to 0.2% by weight based on the total weight of the composition.

3. The thermally curable composition according to claim 1, wherein the amount of the organic vulcanizing agent is 0% by weight.

4. The thermally curable composition according to claim 2, wherein the amount of the chemical blowing agent is 0% by weight.

5. The thermally curable composition according to claim 1, wherein the olefinic double bond-containing polymer (a2) has a styrene content of at least 10% by weight and not more than 60% by weight.

6. The thermally curable composition according to claim 1, wherein the olefinic double bond-containing polymer (a2) has a mass average molecular weight of between 1,000 and 50,000.

7. The thermally curable composition according to claim 1, wherein the olefinic double bond-containing polymer (a2) comprises a diene fraction having vinyl bonds, wherein the vinyl bonds have a ratio to all olefinic double bonds in a range of 20 mol % to 98 mol %.

8. The thermally curable composition according to claim 1, further comprising a vulcanization accelerator(s) in an amount of 0.25% by weight to 20% by weight, based on the total weight of the composition.

9. The thermally curable composition according to claim 1, further comprising a plasticizer (e) in an amount of 2% by weight to 40% by weight, based on the total mass of the composition.

10. The thermally curable composition according to claim 1, wherein:
(a1) the solid rubber is present in an amount of 1.2 to 8% by weight;
(a2) the olefinic double bond-containing polymer which is liquid or pasty at 22° C., is present in an amount of 5 to 15% by weight;
(a3) the hydrocarbon resin is present in an amount of 5 to 22% by weight;
(a4) the liquid polydiene is present in an amount of 3 to 20% by weight;
(b1) the sulfur is present in an amount of 1 to 3% by weight; and
the thermally curable composition further comprises as additional components:
a vulcanization accelerator present in an amount of 0.25 to 20% by weight;
filler present in a total amount of 10 to 50% by weight; and
a plasticizer present in an amount of 2 to 30% by weight;
all % by weight amounts based on the total mass of the composition; and
wherein the components are selected such that the thermally curable composition has a viscosity such that said composition is pumpable with a pump at a temperature in a range of 15 to 60° C.

11. The thermally curable composition according to claim 1, further comprising a filler (d) in an amount of 10% by weight to 45% by weight, based on the total weight of the composition.

12. The thermally curable composition according to claim 1, wherein after thermal curing of the thermally curable composition thereby forming a cured material, the cured material has a loss factor tan δ (50 Hz) measured by a DMA method of 0.5 or more at a temperature in a range of 20° C. to 40° C.

13. Use of the thermally curable composition according to claim 1, as an acoustic attenuating material in an automobile or equipment construction industry.

14. A process for applying the thermally curable composition according to claim 1 comprising: injecting the composition by a pump to a point of application at a temperature in a range of 15 to 60° C.; and applying the composition in a liquid or pasty state onto a substrate.

15. The process of claim 14, further comprising a step of thermal curing, and optional foaming, by heating the composition to a temperature in a range of 160 to 220° C. and maintaining said temperature range for a period of 10 to 60 minutes.
